(19) United States
(12) Patent Application Publication
(10) Pub. No.: US 2015/0113498 A1
(43) Pub. Date: Apr. 23, 2015

(54) MODELING CUSTOMIZATIONS TO A COMPUTER SYSTEM WITHOUT MODIFYING BASE ELEMENTS

(71) Applicant: Microsoft Corporation, Redmond, WA (US)

(72) Inventors: Sean M. Wiese, Bellevue, WA (US); Joshua H. Lange, Seattle, WA (US); Choon Chea Chua, Seattle, WA (US); Nitin Sharma, Redmond, WA (US); Peter Villadsen, Sammamish, WA (US); Ramakanthachary S. Gottumukkala, Sammmamish, WA (US); Zhonghua Chu, Redmond, WA (US)

(73) Assignee: Microsoft Corporation, Redmond, WA (US)

(21) Appl. No.: 14/058,768

(22) Filed: Oct. 21, 2013

(51) Int. Cl. G06F 9/44

(52) U.S. Cl. CPC G06F 8/20
USPC 717/104

(57) ABSTRACT

A customization environment uses a customization system that models customizations to a base computer system. Each set of customizations is stored as a separate extension package, which is stored separately from the code for the base system. During runtime, the extension packages are discovered in a runtime environment and applied to extend the base system, without overwriting any of the code for the base system.

### BACKGROUND

Computer systems are currently in wide use. Some computer systems are relatively large, and may include, for instance, thousands of different user interface and data entities, like tables and other artifacts. Such computer systems are often customized (some heavily customized) before they are deployed in a given implementation.

By way of example, some large computer systems include business systems. Such business systems may include, for instance, enterprise resource planning (ERP) systems, customer relations management (CRM) systems, line-of-business (LOB) systems, among others. These types of business systems often include many thousands of different forms, each of which have many different controls and other user interface elements. Such systems also commonly include a great deal of business logic, as well as workflows and data entities (such as tables) that allow users to access the system and perform a set of activities, or tasks, in order to carry out their duties in conducting the particular business for which they are working.

Various types are modeled in a business system. The models are compiled into assemblies that are run during runtime. The modeled types can represent data or workflow among many other things. For instance, a business system may store information as a collection of entities, where each entity represents an item associated with the business. A customer entity, for example, may represent a customer. A sales order entity, for instance, may represent a sales order. A sales quote entity may represent a sales quote. These are illustrative examples only.

When such a business system is deployed in a specific business, it is common for the business system to be highly customized in order to meet the functional requirements of the particular business in which it is deployed. By way of example, different businesses may wish to have different fields on a given form that represents a customer entity. In addition, different organizations may wish to have different business logic for computing a currency conversion on an expense report form. Thus, it can be seen that a given business system may be heavily customized so that it meets the requirements of a given organization that is using it.

A business system may also have multiple different layers of customization. For instance, a software company that has created and developed the basic business system may simply sell the business system as a base product. An independent software vendor (ISV) may then generate a set of customizations to the base product, so that the base product can be resold with those customizations. A value added reseller (VAR) may add another layer of customizations, and the ultimate end user of the product may be in a partnership with a development partner, where the development partner adds their own customizations.

Currently, when a developer or other programmer authors customizations to a base product, the customizations are used to overwrite the base application models in the base product. The overwriting is achieved by compiling the application model with the changes (to reflect the customizations) already made.

This type of customization can be problematic. For example, when the original software manufacturer attempts to publish an update to the base product, the update may, in some ways, be incompatible with the end user's customizations. Therefore, if the end user attempts to install the update, this can create problems. Further, even where the original software manufacturer is simply attempting to maintain the code base of the base product, this can also create problems where the maintenance conflicts with customizations that a given customer may have made.

The discussion above is merely provided for general background information and is not intended to be used as an aid in determining the scope of the claimed subject matter.

### SUMMARY

A customization environment uses a customization system that models customizations to a base computer system. Each set of customizations is compiled and stored as a separate extension package, which is stored separately from the assemblies for the base system. During runtime, the extension packages are discovered in a runtime environment. The assemblies for the base system are run, along with the separate extension packages, so the customizations are applied to extend the base system, without overwriting any of the code for the base system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative development channel.

FIG. 2 is a block diagram of one illustrative business system architecture.

FIG. 3 is a flow diagram illustrating the operation of the architecture shown in FIG. 2 during customization.

FIG. 4 is a block diagram illustrating one embodiment of extensions to a model.

FIGS. 5 and 6 are illustrative user interface displays.

FIG. 7 shows one embodiment of a runtime environment in more detail.

FIG. 8 is a flow diagram illustrating one embodiment of the operation of the runtime environment shown in FIG. 7, in more detail.

FIG. 9 is a block diagram of the architecture shown in FIG. 2, deployed in a cloud computing architecture.

FIGS. 10-14 show embodiments of mobile devices.

FIG. 15 is a block diagram of one embodiment of a computing environment.

### DETAILED DESCRIPTION

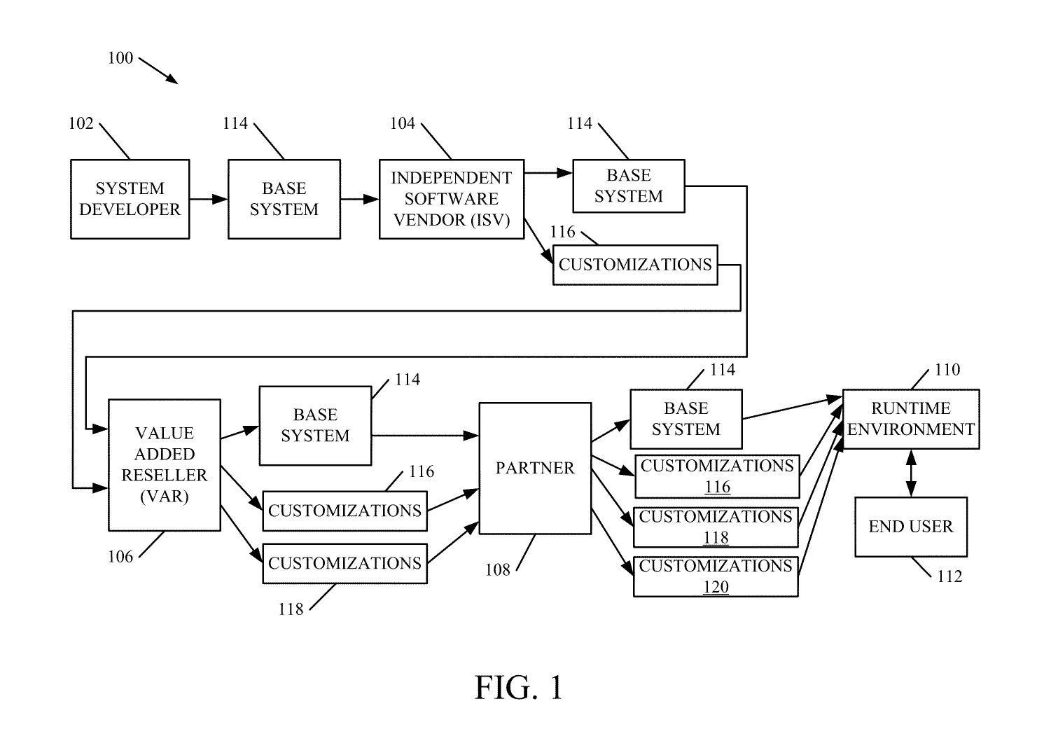

FIG. 1 is a block diagram of one illustrative development channel 100. Development channel 100 may illustratively include system developer 102, independent software vendor (ISV) 104, value added reseller (VAR) 106, partner 108, a runtime system 110 and end user 112. FIG. 1 shows that system developer 102 may illustratively be an original software manufacturer that designs and develops a base software system 114, such as a base business system. For instance, base system 114 may be an ERP system, a CRM system, an LOB system, etc.

Depending on the type of system, it may be that base system 114 is heavily customized or extended before it is deployed in runtime environment 110, for use by end users 112. By way of example, where base system 114 is a business system, independent software vendors 102 often customize base system 114 and make it available to value added resellers 106 which, themselves, customize the base system 114 (after it has already been customized by independent software vendor 104). It may also be that end user 112 is an organization that partners with partner 108 to even further customize the base system 114, to meet the functional requirements of the organization, so that it can be successfully deployed in runtime environment 110. As discussed in the background portion, this can present a number of problems.

Therefore, in development channel 100, any of the various developers (such as ISV 104, VAR 106, or partner 108) that customizes the base system 114, generates the customizations separately, without changing the models in base system 114. For instance, ISV 104 may generate a set of customizations 116, which are stored and maintained separately from base system 104. VAR 106 may, itself, generate a set of customizations 118, which are not only stored separately from base system 114, but which are also stored and maintained separately from customizations 116 that were made by ISV 104. Partner 108 may also make its own customizations 120, which are stored separately as well.

Then, when the base system 114 and customizations 116, 118 and 120 are deployed in runtime environment 110 for end user 112, the base system 114 and customizations 116, 118 and 120 are all compiled into different and isolated assemblies. The compiler can emit code indicating that the assemblies generated for the customizations 116, 118 and 120 are related to certain assemblies in the base system 114. Or, the assemblies for the customizations can be specifically marked to indicate which parts of base system 114 they customize, or they can be stored in specific locations to indicate that they are customization assemblies. The exact way the customization assemblies are marked can vary widely. In any case, the runtime server discovers all of the customizations 116, 118 and 120. The customization assemblies are run along with the assemblies for the base system to apply the customizations to base system 114 during runtime, without ever changing any of the models or assemblies in base system 114 (i.e., they are unaltered). In this way, system developer 102 can easily update base system 114, and maintain it without any impact on the base system. The updates and maintenance can be performed without ever generating conflicts with any of the customizations 116, 118 and 120. Also, the customizations 116, 118 and 120 can be separately maintained as well.

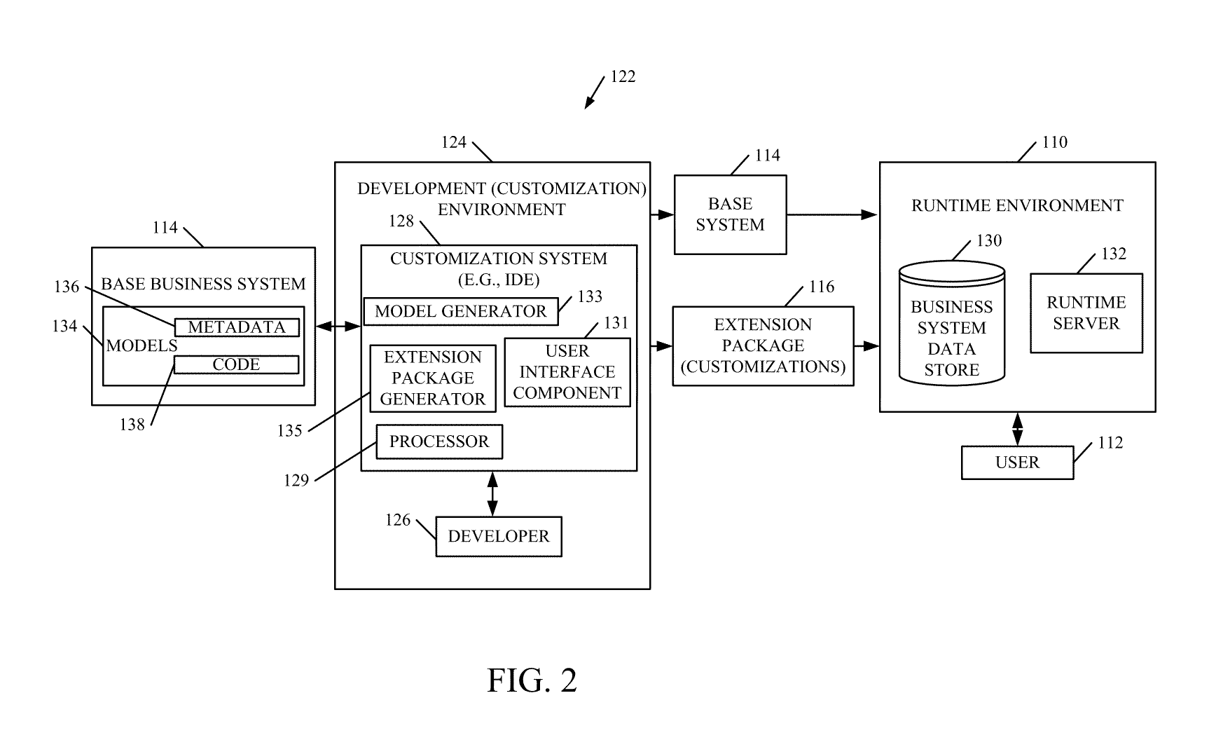

FIG. 2 is block diagram of one embodiment of a business system development architecture 122. Some of the items shown in FIG. 2 are similar to those shown in FIG. 1, and are similarly numbered. Architecture 122 illustratively represents any portion of the development channel 100 shown in FIG. 1. FIG. 2 also shows that, in one embodiment, base system 114 includes models 134. The models 134 illustratively have corresponding metadata 136 and can have code 138 as well.

By way of example, business system development architecture 122 illustratively includes a development environment 124 in which one or more developers 126 use a development and customization system (such as an integrated development environment) 128 to make customizations to the base business system 114. In the embodiment shown in FIG. 2, the development (or customization) environment 124 illustratively corresponds to the environment in which ISV 104 makes customizations 116 to base system 114. It will be noted, however, that development environment 124 can be an environment in which any developer in development channel 100 (shown in FIG. 1), or any other developer in any other channel, makes customizations to a base computer system.

For purposes of the present discussion, customizations will be used to mean additive changes or extensions to the underlying metadata or functionality of base system 114. By way of example only, a customization may be a change to metadata to increase the length of a field on a form. As another example, the customizations can be to add business logic, corresponding to a form, to change a calculation performed on data entered on the form. Of course, these are only examples of how customizations can be made to metadata or code, and a wide variety of other customizations can be made as well. Thus, as used herein, the terms extension and customization are used interchangeably, unless otherwise defined.

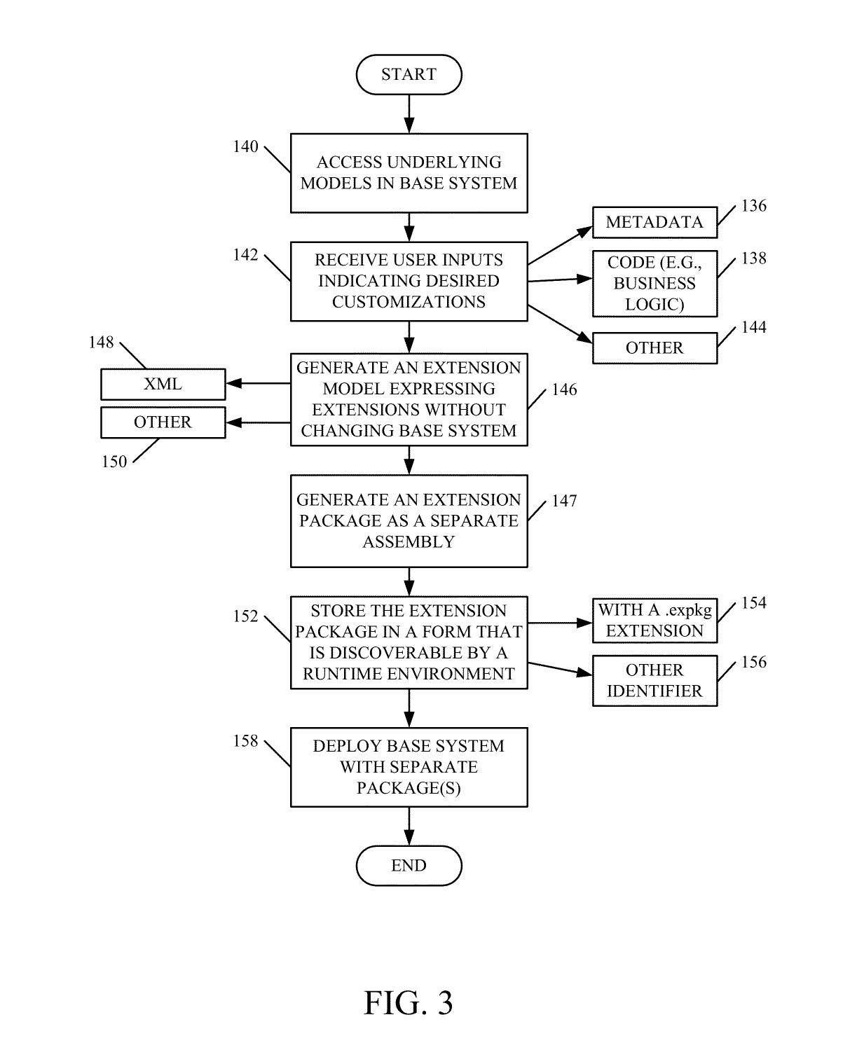

In any case, FIG. 2 shows that runtime environment 110 illustratively includes a processor 129, business system data store 130, user interface component 131, runtime server 132, model generator 133 and extension package generator 135. FIG. 3 is a flow diagram illustrating one embodiment of the operation of business system development architecture 122, shown in FIG. 2, in allowing developer 126 to use customization system 128 to make customizations to base system 114.

FIG. 3 shows that developer 126 can first access the underlying models 134 in base system 114. This is indicated by block 140 in FIG. 3. User interface component 131 in customization system 128 illustratively generates user interface displays that developer 126 can interact with, in order to control and manipulate customization system 128. Thus, customization system 128 receives, through the user interface displays, inputs from developer 126 indicating desired customizations that are to be made to base system 114. This is indicated by block 142 in FIG. 3. By way of example, the customizations can be extensions to metadata 136. They can also be extensions to code 138 (such as adding business logic, etc.). The customizations can be to other items 144 as well.

Based upon the customization inputs received, model generator 133 in customization system 128 generates an extension model that models (or expresses) the extensions (i.e., the customizations), without changing the models in base system 114. This is indicated by block 146 in FIG. 3. The extension model can be generated in a wide variety of different ways. For instance, the extension model can express the extensions in extensible markup language (XML) or any variant of XML 148. It can be expressed in other ways 150 as well.

Extension package generator 135 then generates an extension package from the extension model. This is indicated by block 147 in FIG. 3. In one embodiment, the extension package is a compiled (or assembled) form of the extension model, and it is generated as a separate assembly that is separate from (or isolated from) the assemblies generated for the base models 134 in base system 114.

Customization system 128 then stores the extension packages (shown as extension packages or customizations 116 in FIG. 2) in a form that is readily discoverable by runtime server 132 in runtime environment 110. This is indicated by block 152 in FIG. 3. In one embodiment, the compiler in extension package generator 135 emits code that identifies the extension package as being an assembly that extends a base assembly. In another embodiment, the metadata 136 corresponding to a model 134 that has been extended, has an addition placed therein indicating that an extension package exists for this particular model 134, without overwriting any of the original metadata 136. In another embodiment, the extension package 116 is stored with a certain file extension in a file system that has files with a particular name (such as .expkg or any other suitable file extension) to indicate that it is an extension package that is to be considered by runtime server 132 when a given model 134 is accessed. This is indicated by block 154 in FIG. 3. The extension package (or customizations) 116, can be identified in other ways as well, and this is indicated by block 156.

At some point, the base system 114, along with the separate extension packages (or customizations) 116, are deployed to runtime environment 110. Deploying the base system with the extension packages is indicated by block 158 in FIG. 3.

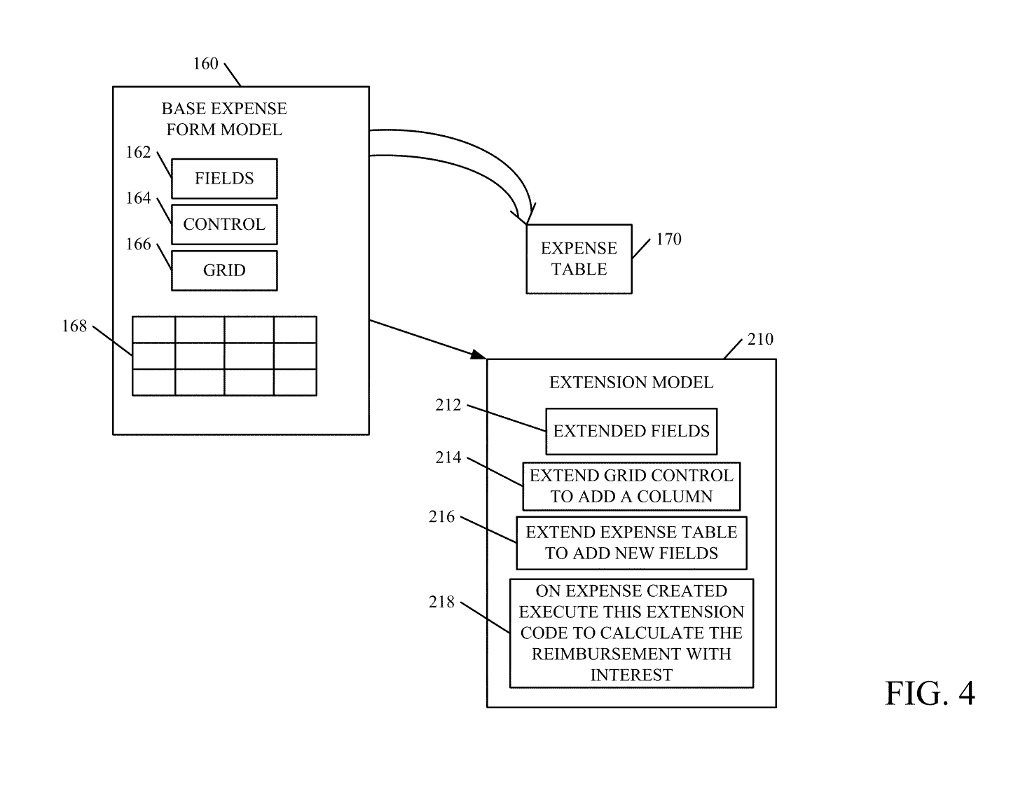

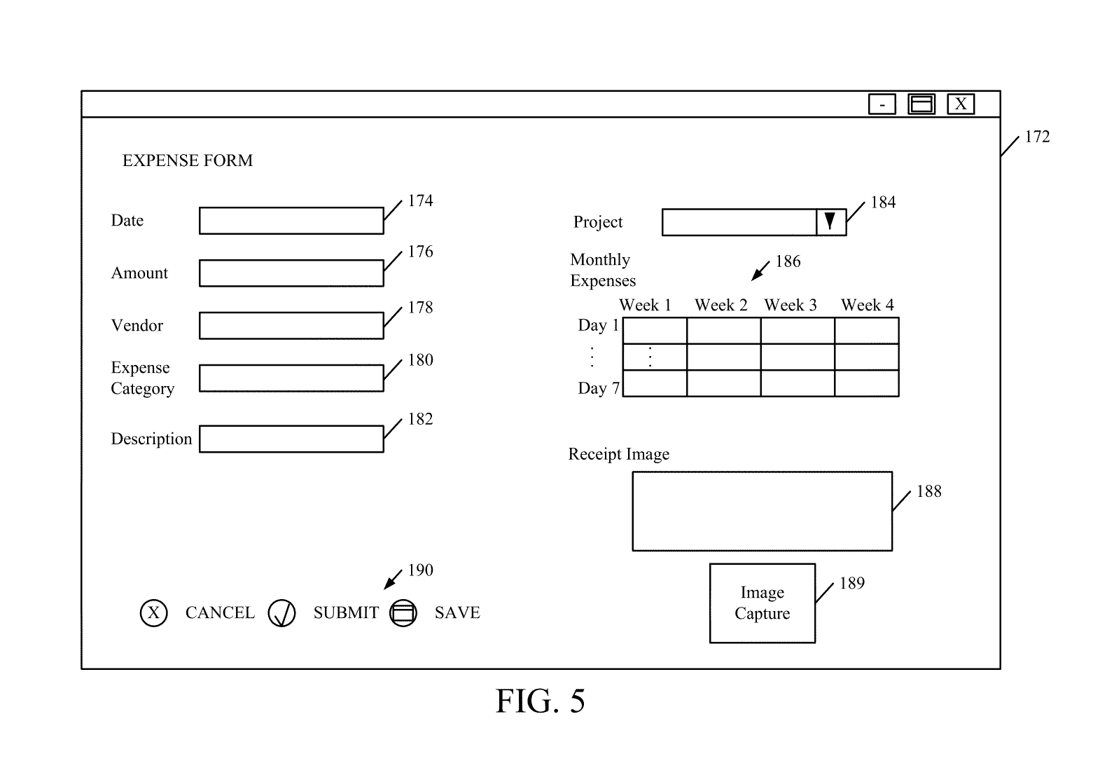

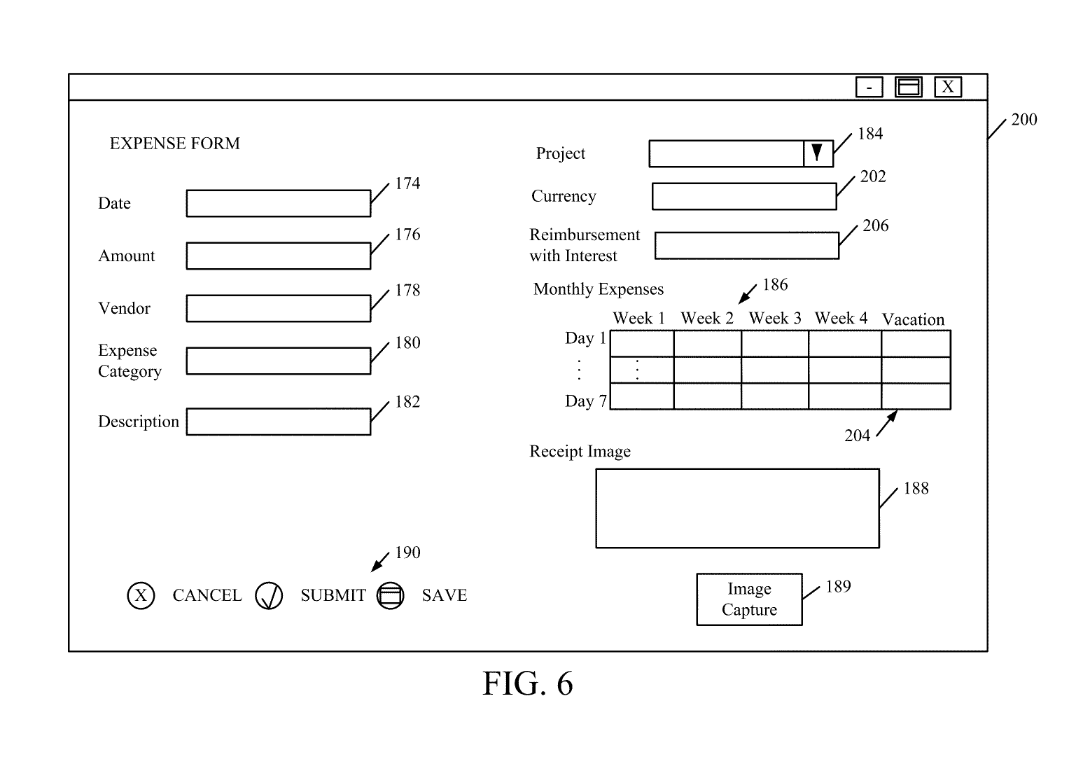

An example may be helpful. FIG. 4 is one block diagram of showing how a particular base model can be extended. FIGS. 5 and 6 are two corresponding user interface displays that indicate this as well. FIGS. 4-6 will now be described in conjunction with one another.

FIG. 4 shows that one model in base system 114 may be a base expense form model 160 that is used to model an expense form that can be pulled up by a user of the business system in order to enter an expense item, or generate an expense report. FIG. 4 shows that the base expense form model includes fields 162, general controls 164, a specific grid control 166, also graphically represented by grid 168 in FIG. 4. Each of the items 162-168 in model 160 is bound to a data source. In the example shown in FIG. 4, they are bound to an expense table 170 which provides data for the items 162-168.

FIG. 5 shows one embodiment of a user interface display of a form 172 that can be generated from base expense form 160. It can be seen that the fields illustratively include a date field 174, an amount field 176, a vendor field 178, an expense category field 180, and a description field 182. Form 172 also includes a project drop down menu control 184. Further, FIG. 5 also shows that form 172 includes a monthly expenses grid 186 that asks the user to enter expenses, as they have occurred, over the current month. In addition, form 172 includes a receipt image display 188 and an image capture control 189 that allows the user to capture an image of a receipt, for the given expense. For instance, when the user actuates control 189, the user is illustratively navigated to a series of user interface camera functionality that allows the user to capture an image of a receipt, and associate it with the expense form represented by user interface display 172.

FIG. 5 also shows that form 172 includes a set of general controls 190 that allow the user to cancel the expense item, to submit the expense form for approval, and to save the expense form.

Assume now that a developer wishes to customize the base expense form model 160 to add a column to grid control 186, and to add a plurality of fields to form 172, and to add business logic. For instance, assume that the developer wishes to add a column to grid 186 to allow the user indicate when they are on vacation. Assume also that the developer wishes to add a currency field to form 172 so that the user can identify the particular currency in which the expense was made. Assume also that the developer wishes add a display that shows the reimbursement amount that will be made to the user, after interest is applied.

FIG. 6, for example, shows another illustrative user interface display 200. User interface display 200 is similar, in some respects, to user interface display 172 shown in FIG. 5, and similar items are similarly numbered. However, FIG. 6 shows a user interface display that reflects a new expense form, that includes the additional fields, controls, and has corresponding business logic, which a developer wishes to add to the base expense form shown in FIG. 5.

FIG. 6, for instance, shows that the developer wishes to add currency field 202 so that the user, when inputting an expense item on an expense form, can indicate the particular currency which was used to make the payment. In addition, user interface display 200 shows that grid 186 now includes a vacation column 204. By way of example, it may be that the organization wishes to know of any business-related expenses that a user made while on vacation. FIG. 6 also shows that the expense form now includes a reimbursement field 206. A new set of business logic is also used to extend the form represented by user interface display 200. For instance, it may be that the organization wishes to repay its employees for business expenses, but also wishes to include interest with that reimbursement. Therefore, a piece of underlying business logic corresponds to the “reimbursement with interest” field 206 so that, when an expense item is created, and the amount and date are entered, the reimbursement with interest is calculated and displayed in field 206. Of course, this is exemplary only and other business logic could be added as well.

Referring again to FIG. 4, the block diagram of FIG. 4 shows an extension model 210 which can be generated by the developer in order to extend the base expense form model 160 to obtain the additional expenses and customizations discussed above with respect to FIG. 6. Developer 126 thus interacts with development and customization system 128 in order to extend the base expense form model 160 so that the form generated on the user interface display is that shown in FIG. 6. Thus, base expense form model 160 is extended to add certain fields and controls. In addition, the expense table 170 is extended to add rows and/or columns that hold data for the extensions to the fields and controls. Further, the business logic that is bound to the extension model 210 includes business logic that is used to calculate the reimbursement with interest. Developer 126 uses model generator 133 in customization system 128 to specifically model the extended fields 212. In the example being discussed, the extended fields include the currency field 202. In addition, developer 126 generates extension model 210 so that it models the extended grid control to add vacation column 204. This is indicated by item 214 in model 210. Developer 126 also uses model generator 133 to add an extension to expense table 170 so that the new data, for the new fields on the extended expense form model, are included in the expense table and are bound to the new fields. This is indicated at block 216 in FIG. 4. In addition, the extension model 210 includes the extended business logic code for calculating the reimbursement with interest that is displayed in field 206. It also illustratively includes the trigger that indicates when that code is to fire. For example, when an expense item is created, the developer 126 may wish for the reimbursement amount with interest to be calculated and displayed. The extension of that business logic code is indicated by block 218 in FIG. 4.

It will be noted that the extensions in extension model 210 are expressed in a wide variety of different ways. Extensions to code are simply represented in the form of the authored code. Metadata extensions can be expressed in XML (or a variant of XML) or in other ways. The extension model 210 is stored as a separate extension model, that is separate from the base expense form model 160. It is illustratively assembled into an extension package that is a separate assembly from the assemblies for the base models so that it can be discovered by a runtime server, during runtime, and used in the runtime implementation of the business system, without overwriting or altering the base system.

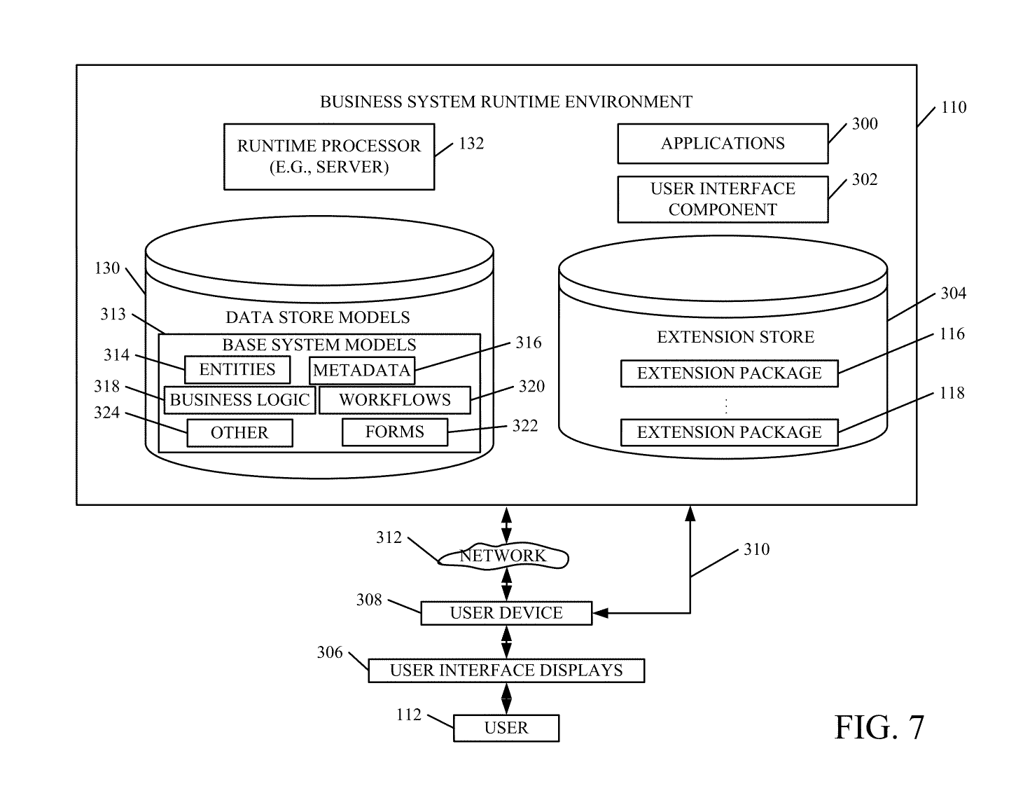

FIG. 7 shows a more detailed block diagram of one runtime environment 110 for the business system (the base business system 114 and its customizations). It can be seen that runtime environment 110 illustratively includes runtime processor (or server) 132 as well as data store 130. The runtime environment 110 can also illustratively include applications 300, a user interface component 302, and an extension data store 304. The runtime environment 110 is shown as being accessible by user 112 through a set of user interface displays 306 generated by a user device 308. User 112 can access environment 110 (through user device 308) either directly, as indicated by arrow 310, or over a network 312. In one embodiment, network 312 is a wide area network, a local area network, or another type of network.

Data store 130 is shown as storing business data, along with business logic and workflows. The data can be stored as entities 314, and metadata 316. Data store 130 also includes business logic 318, workflows 320, forms 322, and a variety of other information 324. Data store 130 can also be comprised of multiple different data stores, such as a data store that stores business data (e.g., invoices, etc.) and a metadata store that stores metadata

Entities 314 illustratively represent individual items within the business system. For example, a customer entity represents a customer. A sales quote entity represents a sales quote, an expense entity represents an expense. These are only a few examples and many others can be used as well. The metadata 316 illustratively describes the data, the forms and form types, tables and table types, fields, business logic, etc. and how they are related to, and interact with, other portions of the business system. Business logic 318 illustratively performs logical operations on data within the business system, and workflows 320 illustratively allow user 112 to interact with user interface displays to perform activities, actions, tasks, etc. in order to conduct the business of the organization that is deploying the business system. As mentioned above, forms 322 illustratively represent user interface displays with user input mechanisms that can be displayed for user interaction by user 112. Runtime processor (or server) 132 illustratively runs applications 300 that access data in data store 130. Applications 300 can be a wide variety of different types of business applications that can be used to conduct the business of the organization deploying the business system. For instance, applications 300 can include a general ledger application, an inventory tracking application, various sales quote and sales order applications, and a variety of other applications that help to automate the tasks performed by user 112 in order to conduct the business of the organization. User interface component 302 illustratively generates user interface displays with user input mechanisms so that user 112 can interact with the business system.

FIG. 7 also shows that, in the runtime environment, extension store 304 is used to store extension packages 116, 118, etc. It will be noted that, in FIG. 7, extension store 304 is shown as a completely separate data store from business data store 130. It will be appreciated, however, that the two data stores can be combined into a single data store, with extension packages 116 and 118 simply being stored separately from the base business system 114, within data store 130. In addition, while two data stores 130 and 304 are shown, and they are both shown as being local to business system runtime environment 110, it will be appreciated that multiple different data stores can be used as well. They can all be local to environment 110, they can all be remote from environment 110 (and accessible by environment 110), or some can be local while others are remote.

User device 308 can be any of a wide variety of different kinds of user devices. It can be a desktop computer, a laptop computer, a tablet, a mobile device (such as a smart phone, a cell phone, etc.). It illustratively includes its own processor and user interface component so that it can generate user interface displays 306 (either on its own or under the direction of user interface component 302). It may also illustratively include a companion application to the business system which resides on the user device. These configurations are mentioned for the sake of example only, and all of them are contemplated herein.

In any case, the base business system models 313 are illustratively stored separate from the various extension models (e.g., extension packages) 116-118, which have been added by developers or other people in the development channel shown in FIG. 1.

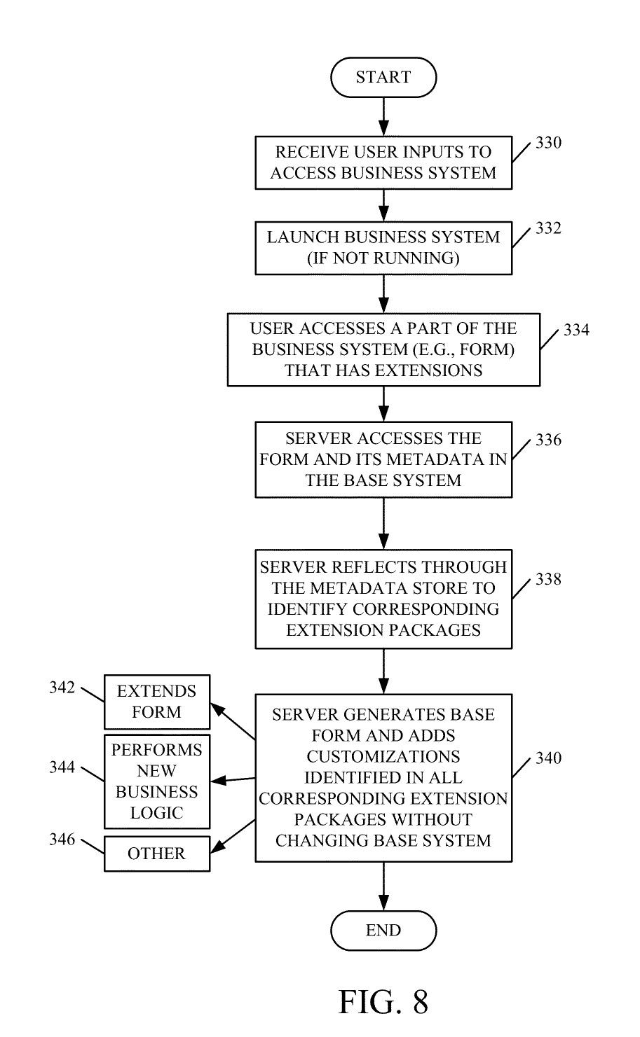

FIG. 8 is a flow diagram illustrating one embodiment of the operation of the runtime environment 110 shown in FIG. 7. FIGS. 7 and 8 will now be described in conjunction with one another.

User 112 first logs on to the business system, or otherwise provides inputs through suitable user interface displays 306 that allow user 112 to access the business system, or to launch the business system (if it is not already running) By way of example, user 112 may provide authentication information (such as a username and password) to sign on to the business system. Receiving user inputs to allow user 112 to access the business system as indicated by block 330 in FIG. 8. If the business system is not already running, it is launched. This is indicated by block 332.

User 112 can then interact with various user interface displays 306 that are generated by the business system runtime environment 110 in order to control and manipulate the business system. At some point, user 112 may access a part of the business system (such as a form) that has corresponding extensions. Having the user access this part of the business system is indicated by block 334 in FIG. 8.

In response to those inputs, runtime processor (e.g., server) 132 accesses that part of the business system in the base business systems and determines whether there are corresponding extension packages. For the sake of the present discussion, it will be assumed that the user has accessed a form with extension packages. However, it will be appreciated that the user could access other parts of the business system that have corresponding extension packages and the discussion of accessing a form with extension packages is provided for the sake of example only. In any case, the server accesses the given form 322 and its corresponding metadata 316 in the base business system models (or assemblies) 313. This is indicated by block 336 in FIG. 8.

Server 132 then reflects through the metadata store (and, for example, extension store 304) to identify any extension packages that correspond to the form that is being accessed by user 112. This is indicated by block 338 in FIG. 8. In one embodiment, server 132 can determine whether any extension packages exist by reflecting through the metadata corresponding to the accessed form. In another embodiment, server 132 reflects through a given memory location (such as extension store 304) only, to identify extension packages that correspond to the form being accessed. The server can reflect through the data store in other ways, or identify corresponding extension packages in other ways as well.

Once the server has located extension packages 116-118, which correspond to the form being accessed, server 132 executes the base assemblies and the separate extension assemblies to generate the base form and to add customizations that have been identified in all corresponding extension packages, without any alterations to the base system 114 (that is, the base models or base assemblies). This is indicated by block 340 in FIG. 8. For example, server 132 can modify the base form to include the additions and extensions to fields, etc. This is indicated by block 342 in FIG. 8. Server 132 can also perform new business logic corresponding to the form. This is indicated by block 344. Server 132 can perform other customizations or extensions to the form as well, and this is indicated by block 346.

It can thus be seen that customizations and extensions can be made to a base business system, without overwriting or otherwise altering the base business system. The extensions are generated and stored in a way that makes them easy to discover by a runtime server. The runtime server identifies extensions to parts of the business system that are being accessed by a user, and applies those extensions, without ever modifying the base business system. This assists in making updates, bug fixes and other maintenance, to the base business system and to the customizations without creating conflicts.

The above discussion has referred to processors and servers. It will be noted these illustratively comprise computer processors with associated memory and time circuitry (which may not be separately shown). The processors and servers comprise a functional part of the system, device or component in which they are included. They are activated by the other components, services, or items and facilitate their functionality.

A number of exemplary user interface displays have also been shown. It will be appreciated, however, that the user interface displays can be generated in a wide variety of different locations, and they can include a wide variety of different user input mechanisms. Those user input mechanisms can include, for example, text boxes, check boxes, buttons, icons, tiles, links, drop down menus, etc. In addition, the user input mechanisms can be actuated in a wide variety of different ways. They can be actuated using a point and click device (such as a mouse or tack ball), using a keypad, a keyboard, a joystick, buttons, actuators, etc. Further, they can be actuated using a virtual keypad or keyboard, virtual buttons, or other virtual elements. Where the device on which the user interface displays are displayed is a touch sensitive screen, the user input mechanisms can also be actuated using touch gestures. Further, where the device used to display the user interface displays has associated speech recognition components, the user input mechanisms can be actuated using voice. Also, where natural input detection and processing are supported (such as touchless motion sensing of body gestures, three dimensional motion capture, facial recognition, retinal scanning, etc.), such gestures can be used to actuate the user input mechanisms.

It will also be appreciated that the drawings shown herein include boxes with certain functionality or components ascribed to them. It will be noted that the functionality can be divided in different ways as well so that more boxes or fewer boxes are included to perform the same functionality.

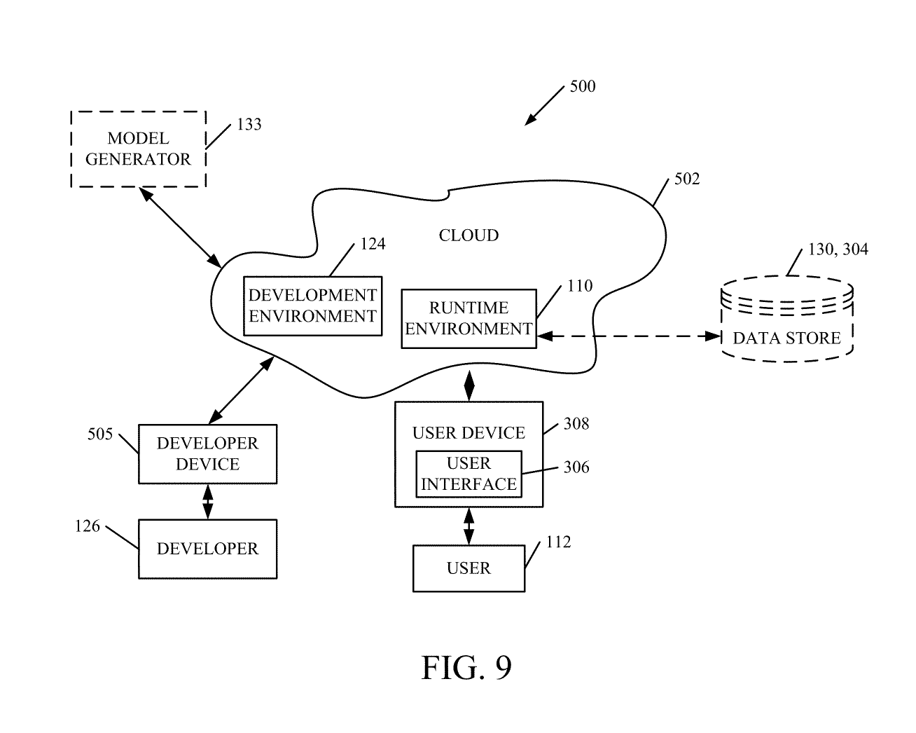

FIG. 9 is a block diagram of architecture 122, shown in FIG. 2, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 122 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware and software. A private cloud may be managed by the organization itself and the infrastructure is typically not shared with other organizations. The organization still maintains the hardware to some extent, such as installations and repairs, etc.

In the embodiment shown in FIG. 9, some items are similar to those shown in FIG. 2 and they are similarly numbered. FIG. 9 specifically shows that both development environment 124 and runtime environment 110 are located in cloud 502 (which can be public, private, or a combination where portions are public while others are private). Therefore, user 112 uses a user device 308 to access those environments through cloud 502. Developer 126 can use a developer device 505 to access the environments through cloud 502.

FIG. 9 also depicts another embodiment of a cloud architecture. FIG. 9 shows that it is also contemplated that some elements of environments 110 and 124 are disposed in cloud 502 while others are not. By way of example, data stores 130, 304 can be disposed outside of cloud 502, and accessed through cloud 502. In another embodiment, model generator 133 and is also outside of cloud 502. Regardless of where they are located, they can be accessed directly by device 308, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 122, or portions of it, can be disposed on a wide variety of different devices. Some of those devices include servers, desktop computers, laptop computers, tablet computers, or other mobile devices, such as handheld computers, cell phones, smart phones, multimedia players, personal digital assistants, etc.

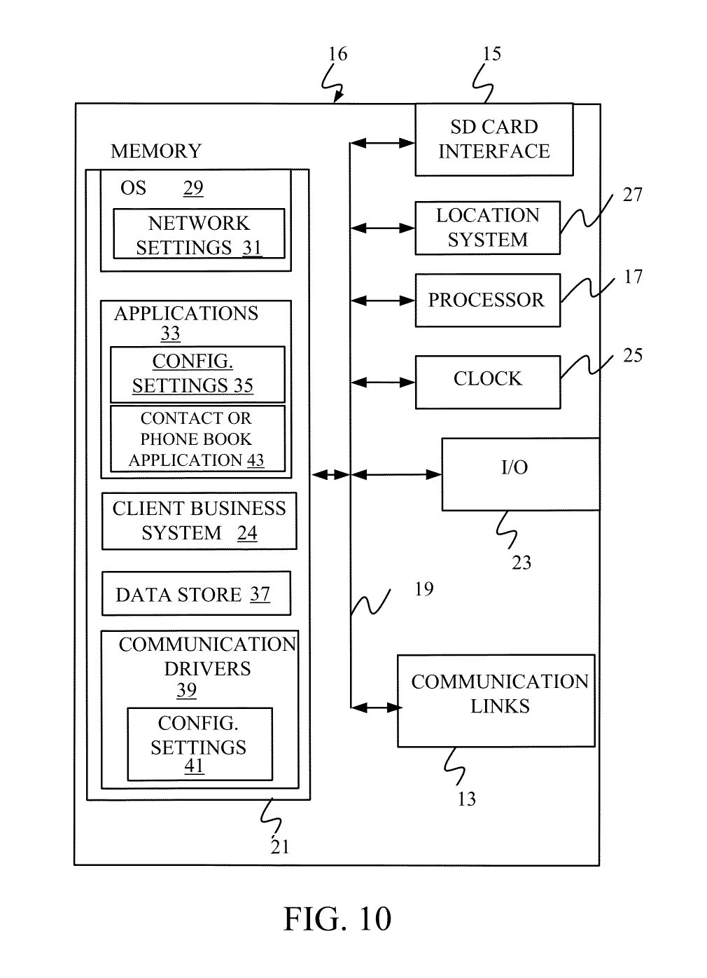

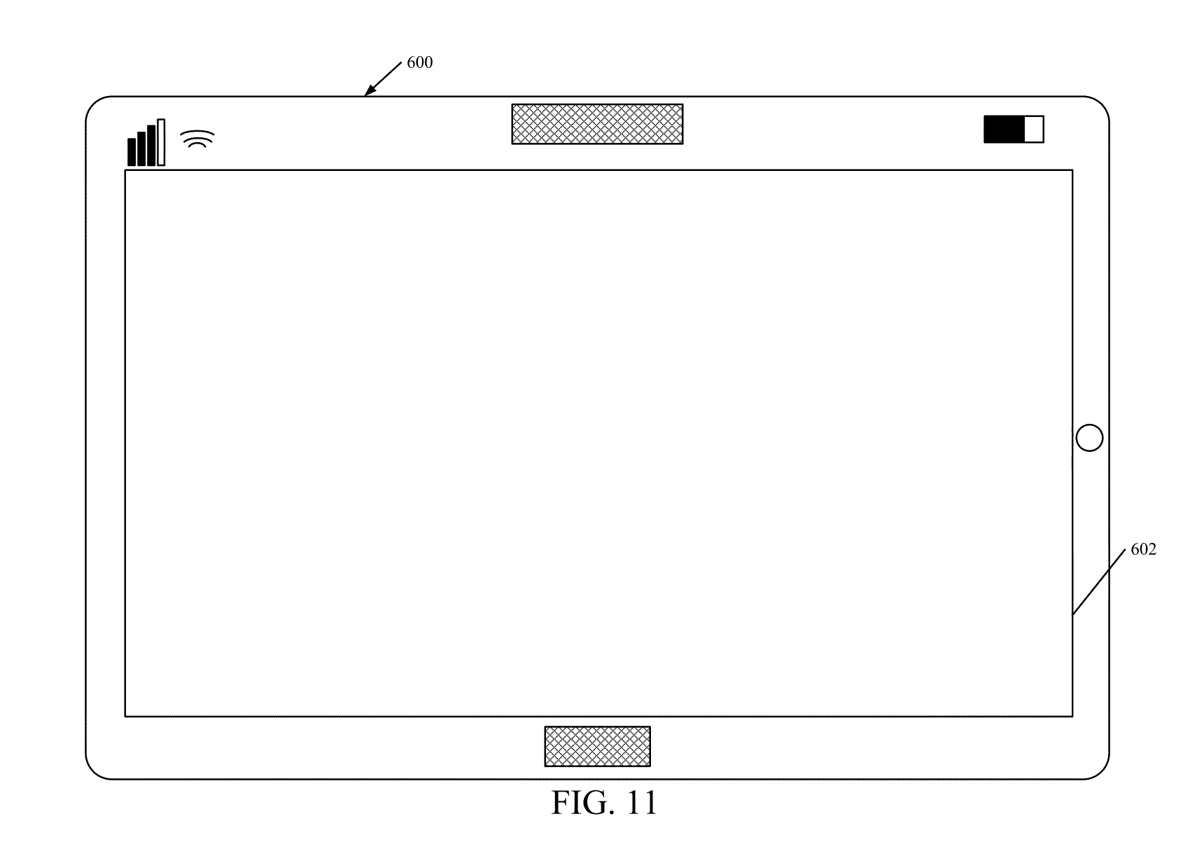

FIG. 10 is a simplified block diagram of one illustrative embodiment of a handheld or mobile computing device that can be used as a user's or client's hand held device 16, in which the present system (or parts of it) can be deployed, or which can be used by a user or developer to access the various environments described herein. FIGS. 11-14 are examples of handheld or mobile devices.

FIG. 10 provides a general block diagram of the components of a client device 16 that can run components of architecture 122 or that interacts with architecture 122, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 129, 132) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 122. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 11 shows one embodiment in which device 16 is a tablet computer 600. In FIG. 11, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

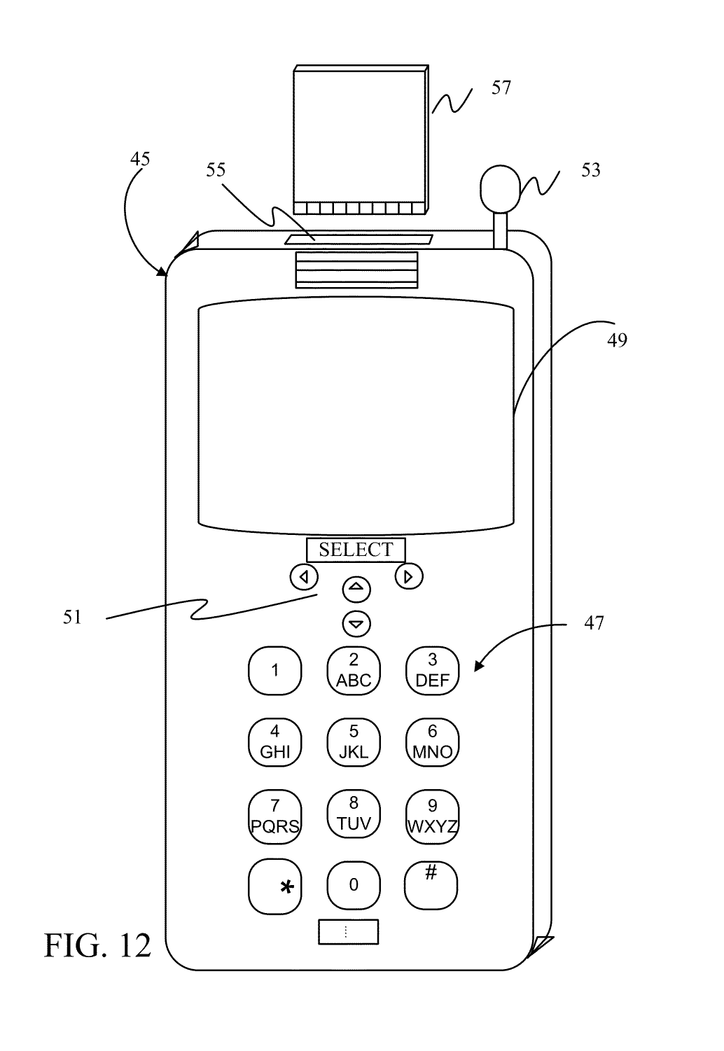

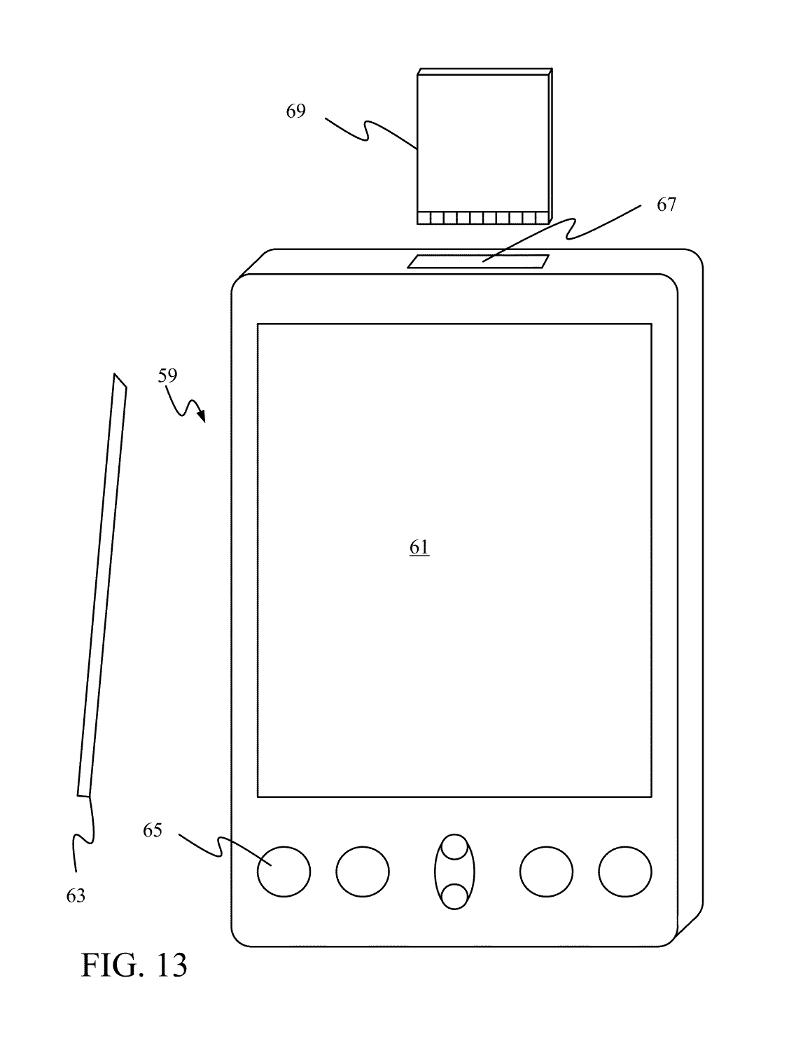

FIGS. 12 and 13 provide additional examples of devices 16 that can be used, although others can be used as well. In FIG. 12, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 13 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

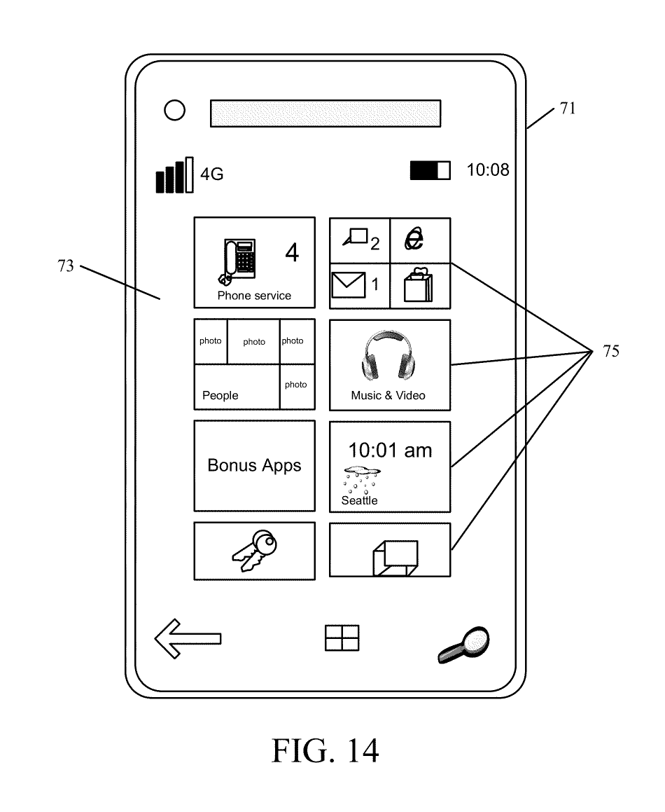

FIG. 14 is similar to FIG. 12 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

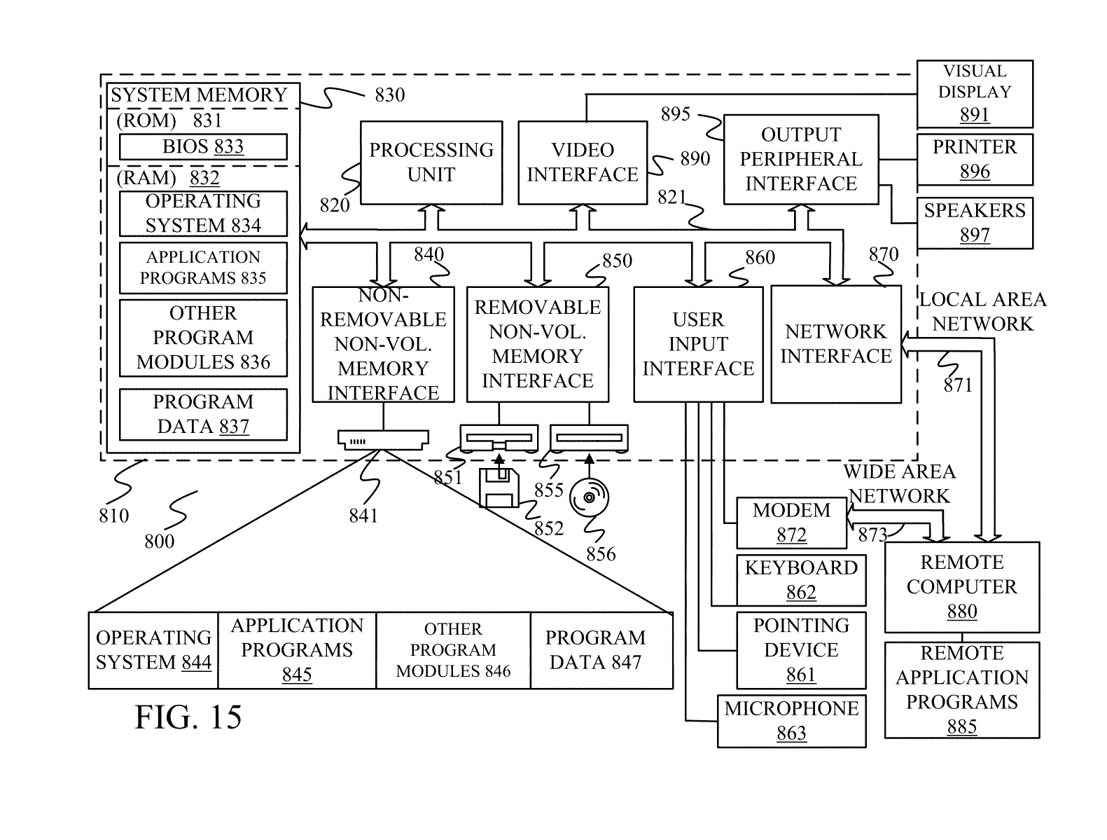

FIG. 15 is one embodiment of a computing environment in which architecture 122, or parts of it, (for example) can be deployed. With reference to FIG. 15, an exemplary system for implementing some embodiments includes a general-purpose computing device in the form of a computer 810. Components of computer 810 may include, but are not limited to, a processing unit 820 (which can comprise processor 129 or 132), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 2 can be deployed in corresponding portions of FIG. 15.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 15 illustrates operating system 834, application programs 835, other program modules 836, and program data 837.

The computer 810 may also include other removable/non-removable volatile/nonvolatile computer storage media. By way of example only, FIG. 15 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 15 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 15 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of customizing a base computer system, comprising:
accessing a base model in the base computer system;
receiving developer inputs to generate an extension model modeling customizations to the base model; and
generating an extension package expressing the customizations modeled in the extension model, the extension package being separate from the base model so the base model is unaltered by the customizations modeled in the extension model.

2. The computer-implemented method of claim 1 and further comprising:
storing the extension package separate from assemblies for the base model, for discovery by a runtime environment.

3. The computer-implemented method of claim 2 wherein the base model comprises a model in a base business system, and wherein accessing the base model comprises accessing the base model in the business system.

4. The computer-implemented method of claim 3 wherein generating an extension package comprises:
generating the extension package to represent extensions to metadata corresponding to the base model.

5. The computer-implemented method of claim 3 wherein generating an extension package comprises:
generating the extension package to represent extensions to code that implements business logic.

6. The computer-implemented method of claim 3 wherein the base model models a base item in the business system and wherein generating an extension package comprises:
generating the extension package to represent extensions to a data source bound to the base item.

7. The computer-implemented method of claim 3 wherein the base model models a business form and wherein generating an extension package comprises:
generating the extension package to represent extensions to the business form.

8. The computer-implemented method of claim 3 wherein the base model models a business form and wherein generating an extension package comprises:
generating the extension package to represent extensions to a control on the business form.

9. The computer-implemented method of claim 3 wherein the base model models a business item and wherein generating an extension package comprises:
generating the extension package to represent extensions to business logic executed in response to manipulation of the business item.

10. The computer-implemented method of claim 3 wherein receiving user inputs comprises receiving user inputs from a first developer and further comprising:
receiving user inputs from a second developer to generate an additional extension model modeling additional customizations to the base model; and
generating an additional extension package expressing the additional customizations modeled in the additional extension model, the additional extension package being separate from the base model and the extension package so the base model and the extension package are unaltered by the extension package.

11. A customization system, comprising:
a model generator that receives user inputs indicative of customizations to a model in a computer system and that generates an extension model that models the customizations;
an extension package generator generating an extension package representing the extension model and storing the extension package separate from the model so the model is unchanged by the extension model; and
a computer processor that is a functional part of the system and activated by the model generator and the extension package generator to facilitate generating the extension model and generating the extension package.

12. The customization system of claim 11 wherein the computer system comprises a business system, wherein the model models a business form in the business system and wherein the extension model models customizations to the business form.

13. The customization system of claim 12 wherein the model generator generates the extension model to model customizations to metadata for the business form or code corresponding to the business form.

14. The customization system of claim 12 wherein the extension model expresses the customizations in extensible markup language (xml) or a variant of xml.

15. The customization system of claim 12 wherein the extension package generator generates the extension package by compiling the extension model and emitting code that ties the extension package to a type modeled by the model.

16. A computer readable storage medium that stores computer executable instructions which, when executed by a computer, cause the computer to perform steps comprising:
accessing a model that models a type in a computer system;
receiving user inputs to generate an extension model modeling customizations to the model;
generating an extension package expressing the customizations modeled in the extension model, the extension package being separate from the model so the model is unchanged by the customizations modeled in the extension model; and
storing the extension package separate from the model, for discovery by a runtime environment.

17. The computer readable storage medium of claim 16 wherein the model comprises a model in a business system, and wherein accessing the model comprises accessing the model in the business system.

18. The computer readable storage medium of claim 17 wherein generating an extension package comprises:
generating the extension package to represent extensions to metadata corresponding to the model or extensions to code that implements business logic.

19. The computer readable storage medium of claim 17 wherein the model models a form in the business system and wherein generating an extension package comprises:
generating the extension package to represent extensions to a data source bound to the form.

20. The computer readable storage medium of claim 17 wherein the model models a business form and wherein generating an extension package comprises:
generating the extension package to represent extensions to a visual element on the business form when the business form is displayed.
